(19) United States
(12) Patent Application Publication
(10) Pub. No.: US 2020/0364811 A1
(43) Pub. Date: Nov. 19, 2020

(54) METHODS AND SYSTEMS FOR FACILITATING AN INTEGRATED PROVISIONING OF MORTGAGE SERVICE AND BROKERAGE SERVICE TO BUYERS

(71) Applicant: Kazuyuki Nagashima, El Segundo, CA (US)

(72) Inventor: Kazuyuki Nagashima, El Segundo, CA (US)

(21) Appl. No.: 16/574,429

(22) Filed: Sep. 18, 2019

Related U.S. Application Data
(60) Provisional application No. 62/847,056, filed on May 13, 2019.

(51) Int. Cl. G06Q 50/16; G06Q 40/02

(52) U.S. Cl. CPC G06Q 50/163; G06Q 40/025

(57) ABSTRACT

Disclosed is a method of facilitating an integrated provisioning of mortgage service and brokerage service to a buyer. The method may include receiving, using a communication device, a mortgage request from a buyer device. Further, the method may include generating, using a processing device, a mortgage transaction identifier based on the mortgage request. Further, the method may include receiving, using the communication device, a brokerage request from the buyer device. Further, the method may include generating, using the processing device, a brokerage transaction identifier based on the brokerage request. Further, the method may include comparing, using the processing device, the mortgage transaction identifier and the brokerage transaction identifier. Further, the method may include generating, using the processing device, at least one monetary benefit based on the comparing. Further, the method may include transmitting, using the communication device, an indication of the at least one monetary benefit to the buyer device.

### FIELD OF THE INVENTION

Generally, the present disclosure relates to the field of data processing. More specifically, the present disclosure relates to methods and systems for facilitating an integrated provisioning of mortgage service and brokerage service to buyers.

### BACKGROUND

Conventional methods for purchasing real estate properties include a buyer interacting with mortgage lenders and real estate brokers. Further, the mortgage lenders are individuals and/or companies that loan money for the purchase of the real estate property. Further, the real estate brokers are individuals and/or companies that are licensed by the state to negotiate sales agreements and manage the documentation required for closing real estate transactions. Further, both the mortgage lenders and the real estate brokers receive a commission from the purchase for successfully completing a sale. However, there is little to no financial incentives (such as a discount or a refund) given to the buyers in the purchase.

Therefore, there is a need for improved methods and systems for facilitating combining of mortgage business and brokerage business to provide financial incentives to real estate buyers that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some aspects, a method of facilitating an integrated provisioning of mortgage service and brokerage service to a buyer is disclosed. The method may include receiving, using a communication device, a mortgage request from a buyer device. Further, the mortgage request may be associated with a real estate property. Further, the method may include generating, using a processing device, a mortgage transaction identifier based on the mortgage request. Further, the method may include receiving, using the communication device, a brokerage request from the buyer device. Further, the brokerage request may be associated with the real estate property. Further, the method may include generating, using the processing device, a brokerage transaction identifier based on the brokerage request. Further, the method may include comparing, using the processing device, the mortgage transaction identifier and the brokerage transaction identifier. Further, the method may include generating, using the processing device, at least one monetary benefit based on the comparing. Further, the at least one monetary benefit may be associated with at least one of a mortgage service fee and a brokerage service fee. Further, the method may include transmitting, using the communication device, an indication of the at least one monetary benefit to the buyer device.

According to some aspects, a method of facilitating an integrated provisioning of mortgage service and brokerage service to a buyer is disclosed. The method may include receiving, using a communication device, a mortgage request from a buyer device. Further, the mortgage request may be associated with a real estate property. Further, the method may include receiving, using the communication device, a brokerage request from the buyer device. Further, the brokerage request may be associated with the real estate property. Further, the method may include identifying, using a processing device, a combined professional based on each of the mortgage request and the brokerage request. Further, the combined professional may be qualified to deliver each of a mortgage service and a brokerage service. Further, the method may include transmitting, using the communication device, each of the mortgage request and the brokerage request to a combined professional device associated with the combined professional. Further, the method may include receiving, using the communication device, each of a mortgage service fee associated with the mortgage service and a brokerage service fee associated with the brokerage service from the combined professional device. Further, the method may include receiving, using the communication device, at least one of a mortgage fee discount and a brokerage fee discount from the combined professional device. Further, the method may include transmitting, using the communication device, an indication of the at least one of the mortgage fee discount and the brokerage fee discount to the buyer device. Further, at least one of a mortgage fee payment may be associated with the mortgage service and a brokerage fee payment associated with the brokerage service may be based on at least one of the mortgage fee discount and the brokerage fee discount.

According to some aspects, a system of facilitating an integrated provisioning of mortgage service and brokerage service to a buyer. The system may include a communication device and a processing device. Further, the communication device may be configured for receiving a mortgage request from a buyer device. Further, the mortgage request may be associated with a real estate property. Further, the communication device may be configured for receiving a brokerage request from the buyer device. Further, the brokerage request may be associated with the real estate property. Further, the communication device may be configured for transmitting an indication of the at least one monetary benefit to the buyer device. Further, the processing device may be configured for generating a mortgage transaction identifier based on the mortgage request. Further, the processing device may be configured for generating a brokerage transaction identifier based on the brokerage request. Further, the processing device may be configured for comparing the mortgage transaction identifier and the brokerage transaction identifier. Further, the processing device may be configured for generating at least one monetary benefit based on the comparing. Further, the at least one monetary benefit may be associated with at least one of a mortgage service fee and a brokerage service fee.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system to facilitate an integrated provisioning of mortgage service and brokerage service to a buyer in accordance with some embodiments.

FIG. 3 is a block diagram of the system to facilitate an integrated provisioning of mortgage service and brokerage service to a buyer in accordance with some embodiments.

FIG. 4 is a flowchart of a method to facilitate an integrated provisioning of mortgage service and brokerage service to a buyer in accordance with some embodiments.

FIG. 5 is a flowchart of a method to facilitate obtaining a rebate amount in accordance with further embodiments.

FIG. 6 is a flowchart of a method to facilitate obtaining the mortgage service fee in accordance with further embodiments.

FIG. 7 is a flowchart of a method to facilitate obtaining the brokerage service fee in accordance with further embodiments.

FIG. 8 is a flowchart of a method to facilitate ascertaining the buyer eligibility for a mortgage in accordance with further embodiments.

FIG. 9 is a flowchart of a method to facilitate an integrated provisioning of mortgage service and brokerage service to a buyer in accordance with some embodiments.

FIG. 10 is a flowchart of a method to facilitate ascertaining the buyer eligibility for a mortgage in accordance with further embodiments.

FIG. 11 is a flowchart of a method to facilitate ascertaining the eligibility of the combined professional in accordance with further embodiments.

FIG. 12 is a flowchart of a method to facilitate registering a user as a property advisor, in accordance with some embodiments.

FIG. 13 is a flowchart of a method to facilitate combining mortgage business and brokerage business to provide financial incentives to real estate buyers, in accordance with some embodiments.

FIG. 14 is a flowchart of a method to facilitate determining a rebate amount for a purchase of a real estate property, in accordance with some embodiments.

FIG. 15 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

The present disclosure includes many aspects and features. Moreover, while many aspects and features relate to, and are described in the context of online shopping experience, embodiments of the present disclosure are not limited to use only in this context.

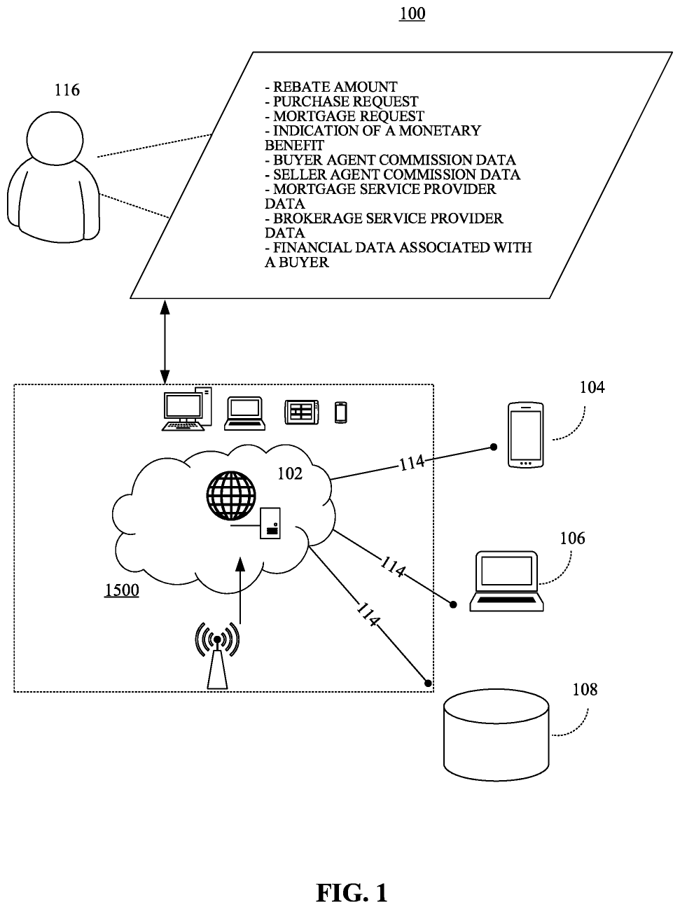

FIG. 1 is an illustration of an online platform 100 consistent with various embodiments of the present disclosure. By way of non-limiting example, the online platform 100 to facilitate combining of mortgage business and brokerage business to provide financial incentives to real estate buyers may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), and databases 108, over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform 100.

A user 116, such as the one or more relevant parties, may access online platform 100 through a web based software application or browser. The web based software application may be embodied as, for example, but not be limited to, a website, a web application, a desktop application, and a mobile application compatible with a computing device 1500.

The online platform 100, in an instance, may be configured to provide a user interface for a web-based application that may be operated by a user (such as a homebuyer/real estate buyer) through one or more user devices. Further, the one or more user devices may include devices such as, but not limited to, smartphones, computer tablets, laptops, smart watches, and so on. Further, the one or more user devices may be configured to communicate over a communication network such as, but not limited to, a cellular network, a satellite network, a personal area network, Bluetooth, Internet and so on.

Further, the web-based application may be used by the user (such as a real estate buyer), where the user may request, with a push of a button, assistance for mortgage and brokerage that may be involved in real-estate buying process. For instance, a registered user (such as a property advisor) may be configured to provide mortgage and brokerage assistance to the homebuyer and providing financial incentives (such as rebate of brokerage commission) to the homebuyer.

Further, the online platform 100 may allow users to create user profiles on the online platform 100. For instance, user profiles may include real estate buyer profiles, property advisor profiles, and administrator profiles. The user profiles may include information about the users, such as name, age, gender, location, and so on. Further, all personal information other than the name of the user, in an instance, may be anonymous and/or may not be shared. Further, the online platform 100, in an instance, may be configured to verify the information provided by the user by retrieving information from one or more databases (such as the databases 108). Further, the one or more databases may include at least one of government verified databases (such as, but not limited to, Nationwide Mortgage Licensing System, California Department of real estate, State of New Jersey Department of banking and insurance real estate commission), educational institution databases, and medical databases. Further, information in the user profile may depend on the type of user profile. For instance, a property advisor profile may include license information such as a Mortgage Loan Originator (MLO) license associated with the property advisor, and a real estate license associated with the property advisor. Further, administrator profiles may include administrative privileges, such as viewing profile information related to one or more users, allow one or more users to join, and so on, and may correspond to one or more departments.

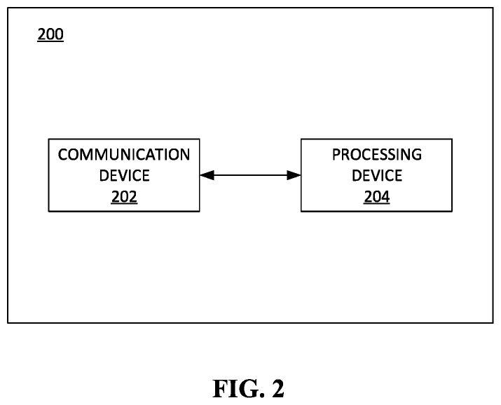

FIG. 2 is a block diagram of a system 200 to facilitate an integrated provisioning of mortgage service and brokerage service to a buyer in accordance with some embodiments. Further, the system 200 may include a communication device 202 and a processing device 204.

Further, the communication device 202 may be configured for receiving a mortgage request from a buyer device (such as the mobile device 104 and an electronic device in the electronic devices 106). Further, the mortgage request may be associated with a real estate property. Further, the mortgage request may include a request for financial funding for the purchase of the real estate property.

Further, the communication device 202 may be configured for receiving a brokerage request from the buyer device. Further, the brokerage request may be associated with the real estate property. Further, the brokerage request may include a request to communicate with a seller of the real estate property.

Further, the communication device 202 may be configured for transmitting an indication of the at least one monetary benefit to the buyer device. Further, the at least one monetary benefit may include at least one of a mortgage fee discount and a brokerage fee discount associated with the at least one of the mortgage service fee and the brokerage service fee.

Further, the processing device 204 may be configured for generating a mortgage transaction identifier based on the mortgage request. Further, the processing device 204 may be configured for generating a brokerage transaction identifier based on the brokerage request. Further, the processing device 204 may be configured for comparing the mortgage transaction identifier and the brokerage transaction identifier. Further, the processing device 204 may be configured for generating at least one monetary benefit based on the comparing. Further, the at least one monetary benefit may be associated with at least one of a mortgage service fee and a brokerage service fee.

In further embodiments, the communication device 202 may be configured for receiving buyer agent commission data from a buyer agent device (such as the mobile device 104 and an electronic device in the electronic devices 106) associated with a buyer agent, wherein the buyer agent may facilitate the purchase of the real estate property. Further, the communication device 202 may be configured for receiving seller agent commission data from a seller agent device (such as the mobile device 104 and an electronic device in the electronic devices 106) associated with a seller agent, wherein the seller agent may facilitate the selling of the real estate property. Further, the processing device 204 may be configured for calculating a rebate amount based on a first percent of the seller agent commission data and a second percent of the buyer agent commission data.

In further embodiments, the communication device 202 may be configured for receiving mortgage service provider data from a mortgage service provider device (such as the mobile device 104 and an electronic device in the electronic devices 106) associated with a mortgage service provider. Further, the processing device 204 may be configured for analyzing the mortgage service provider data and the mortgage request to determine the mortgage service fee.

In further embodiments, the communication device 202 may be configured for receiving brokerage service provider data form a brokerage service provider device (such as the mobile device 104 and an electronic device in the electronic devices 106) associated with a brokerage service provider. Further, the processing device 204 configured for analyzing the broker service provider data and the brokerage request to determine the brokerage service fee.

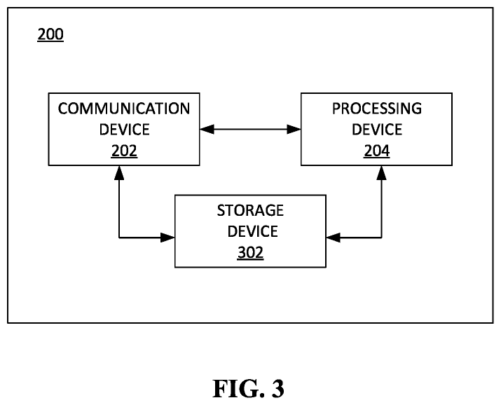

In further embodiments, the system 200 may include a storage device 302 (shown in FIG. 3) communicatively coupled with the processing device 204. Further, the storage device may be configured for retrieving financial data associated with a buyer. Further, the processing device 204 may be configured for analyzing the financial data to determine the buyer eligibility for a mortgage.

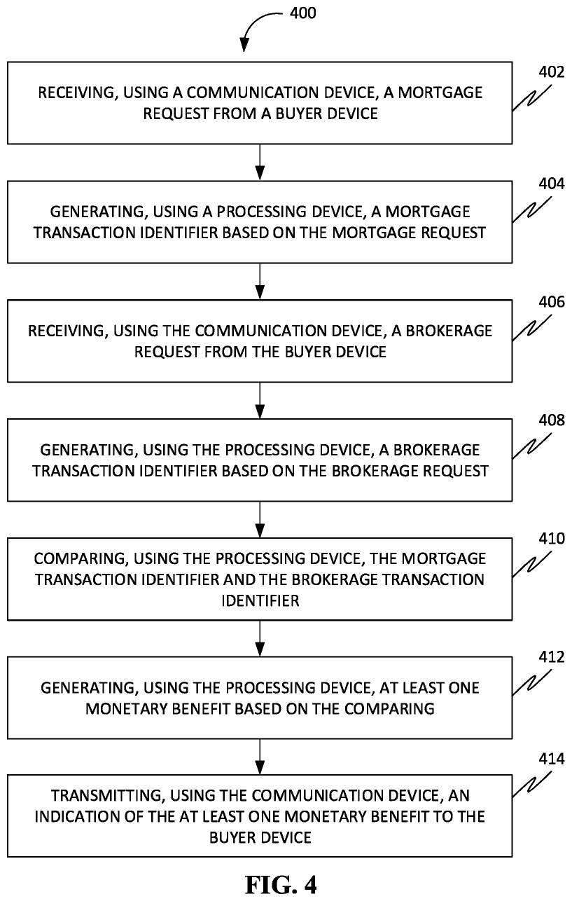

FIG. 4 is a flowchart of a method 400 to facilitate an integrated provisioning of mortgage service and brokerage service to a buyer in accordance with some embodiments. At 402, the method 400 may include receiving, using a communication device (such as the communication device 202), a mortgage request from a buyer device. Further, the mortgage request may be associated with a real estate property.

Further, at 404, the method 400 may include generating, using a processing device (such as the processing device 204), a mortgage transaction identifier based on the mortgage request. Further, the mortgage request may include a request for financial funding for the purchase of the real estate property.

Further, at 406, the method 400 may include receiving, using the communication device, a brokerage request from the buyer device. Further, the brokerage request may be associated with the real estate property. Further, the brokerage request may include a request to communicate with a seller of the real estate property.

Further, at 408, the method 400 may include generating, using the processing device, a brokerage transaction identifier based on the brokerage request.

Further, at 410, the method 400 may include comparing, using the processing device, the mortgage transaction identifier and the brokerage transaction identifier.

Further, at 412, the method 400 may include generating, using the processing device, at least one monetary benefit based on the comparing. Further, the at least one monetary benefit may be associated with at least one of a mortgage service fee and a brokerage service fee. Further, the at least one monetary benefit may include at least one of a mortgage fee discount and a brokerage fee discount associated with the at least one of the mortgage service fee and the brokerage service fee.

Further, at 414, the method 400 may include transmitting, using the communication device, an indication of the at least one monetary benefit to the buyer device.

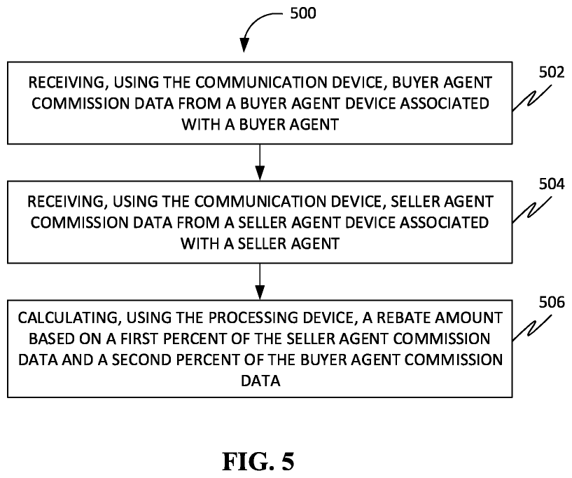

FIG. 5 is a flowchart of a method 500 to facilitate obtaining a rebate amount in accordance with further embodiments. At 502, the method 500 may include receiving, using the communication device, buyer agent commission data from a buyer agent device associated with a buyer agent, wherein the buyer agent may facilitate the purchase of the real estate property.

Further, at 504, the method 500 may include receiving, using the communication device, seller agent commission data from a seller agent device associated with a seller agent, wherein the seller agent may facilitate the selling of the real estate property.

Further, at 506, the method 500 may include calculating, using the processing device, the rebate amount based on a first percent of the seller agent commission data and a second percent of the buyer agent commission data.

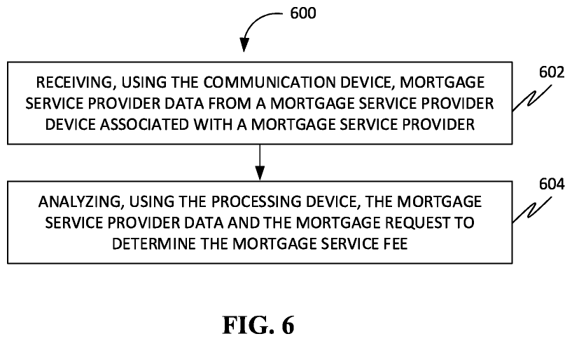

FIG. 6 is a flowchart of a method 600 to facilitate obtaining the mortgage service fee in accordance with further embodiments. At 602, the method 600 may include receiving, using the communication device, mortgage service provider data from a mortgage service provider device associated with a mortgage service provider.

Further, at 604, the method 600 may include analyzing, using the processing device, the mortgage service provider data and the mortgage request to determine the mortgage service fee.

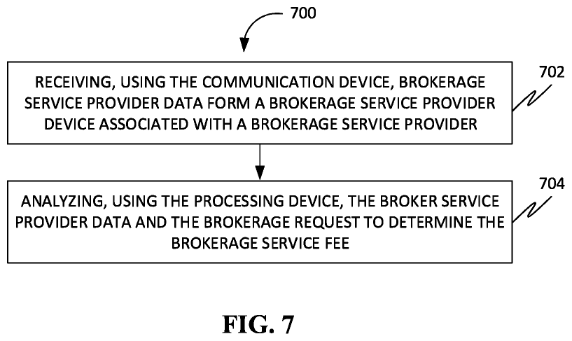

FIG. 7 is a flowchart of a method 700 to facilitate obtaining the brokerage service fee in accordance with further embodiments. At 702, the method 700 may include receiving, using the communication device, brokerage service provider data form a brokerage service provider device associated with a brokerage service provider.

Further, at 704, the method 700 may include analyzing, using the processing device, the broker service provider data and the brokerage request to determine the brokerage service fee.

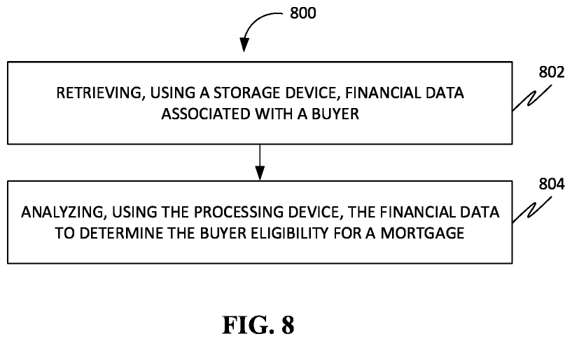

FIG. 8 is a flowchart of a method 800 to facilitate ascertaining the buyer eligibility for a mortgage in accordance with further embodiments. At 802, the method 800 may include retrieving, using a storage device (such as the storage device 302), financial data associated with a buyer, wherein the storage device may be communicatively coupled with the processing device. Further, at 804, the method 800 may include analyzing, using the processing device, the financial data to determine the buyer eligibility for a mortgage.

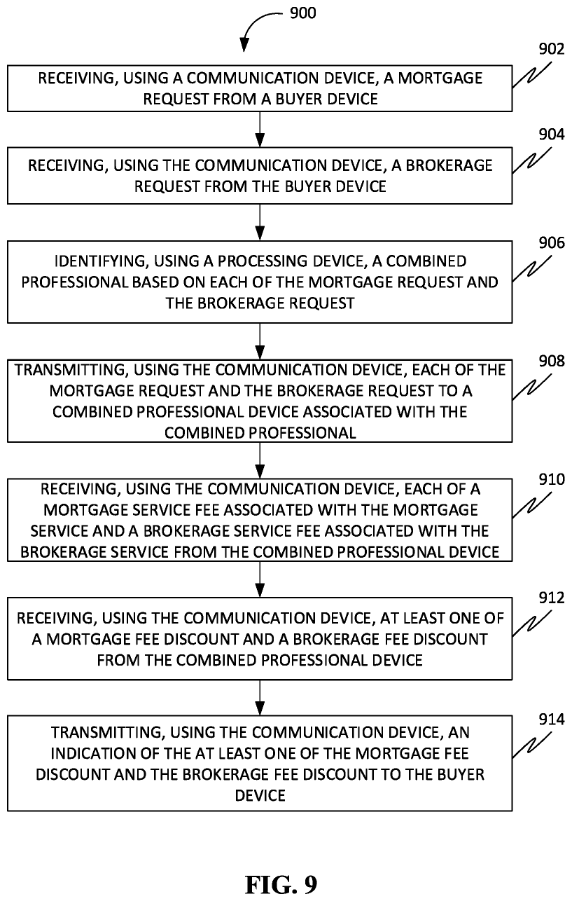

FIG. 9 is a flowchart of a method 900 to facilitate an integrated provisioning of mortgage service and brokerage service to a buyer in accordance with some embodiments. At 902, the method 900 may include receiving, using a communication device (such as the communication device 202), a mortgage request from a buyer device. Further, the mortgage request is associated with a real estate property.

Further, at 904, the method 900 may include receiving, using the communication device, a brokerage request from the buyer device. Further, the brokerage request is associated with the real estate property.

Further, at 906, the method 900 may include identifying, using a processing device (such as the processing device 204), a combined professional based on each of the mortgage request and the brokerage request. Further, the combined professional may be qualified to deliver each of a mortgage service and a brokerage service.

Further, at 908, the method 900 may include transmitting, using the communication device, each of the mortgage request and the brokerage request to a combined professional device associated with the combined professional.

Further, at 910, the method 900 may include receiving, using the communication device, each of a mortgage service fee associated with the mortgage service and a brokerage service fee associated with the brokerage service from the combined professional device.

Further, at 912, the method 900 may include receiving, using the communication device, at least one of a mortgage fee discount and a brokerage fee discount from the combined professional device.

Further, at 914, the method 900 may include transmitting, using the communication device, an indication of the at least one of the mortgage fee discount and the brokerage fee discount to the buyer device. Further, at least one of a mortgage fee payment associated with the mortgage service and a brokerage fee payment associated with the brokerage service may be based on at least one of the mortgage fee discount and the brokerage fee discount.

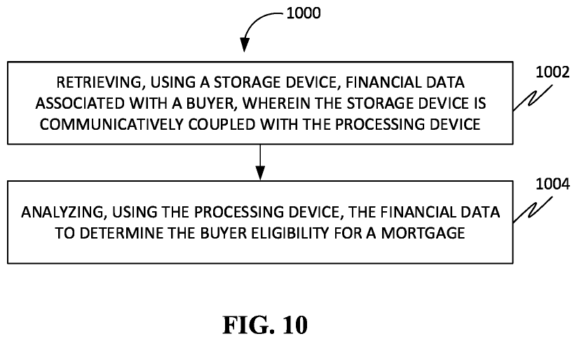

FIG. 10 is a flowchart of a method 1000 to facilitate ascertaining the buyer eligibility for a mortgage in accordance with further embodiments. At 1002, the method 1000 may include retrieving, using a storage device, financial data associated with a buyer, wherein the storage device may be communicatively coupled with the processing device.

Further, at 1004, the method 1000 may include analyzing, using the processing device, the financial data to determine the buyer eligibility for a mortgage.

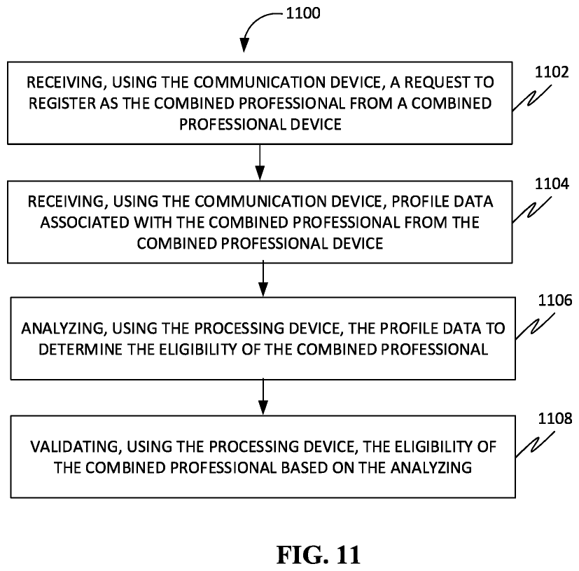

FIG. 11 is a flowchart of a method 1100 to facilitate ascertaining the eligibility of the combined professional in accordance with further embodiments. At 1102, the method 1100 may include receiving, using the communication device, a request to register as the combined professional from a combined professional device.

Further, at 1104, the method 1100 may include receiving, using the communication device, profile data associated with the combined professional from the combined professional device.

Further, at 1106, the method 1100 may include analyzing, using the processing device, the profile data to determine the eligibility of the combined professional.

Further, at 1108, the method 1100 may include validating, using the processing device, the eligibility of the combined professional based on the analyzing. Further, the eligibility of the combined professional may be validated based on a third-party database (such as a database in the databases 108), wherein the third party database may be associated with a third party.

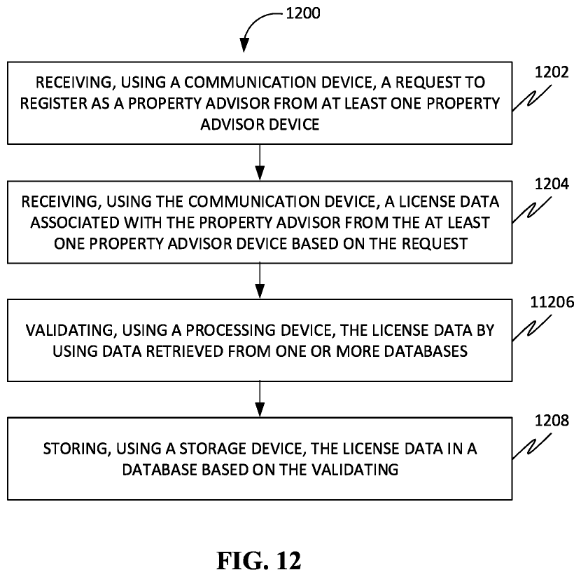

FIG. 12 is a flowchart of a method 1200 to facilitate registering a user as a property advisor, in accordance with some embodiments. Accordingly, at 1202, the method 1200 may include a step of receiving, using a communication device, a request to register as a property advisor from at least one property advisor device. Further, the property advisor, in an instance, may be an individual (and/or a firm) that may be holding both real estate salesperson license and Mortgage Loan Originator (MLO) license in order to provide assistance to a real estate buyer. For instance, the property advisor may be an authorized professional that may act as a real estate broker and a loan officer in a manner such that the real estate buyer may receive some financial incentives (such as rebate of brokerage commission). Further, the property advisor, in an instance, may interact with the at least one property advisor device in order to register with the online platform 100. For instance, the property advisor may select (for e.g. by tapping on a touchscreen panel of the at least one property advisor device, and/or clicking on a section using a trackpad of the at least one property advisor device) an option such as “register as a property advisor” that may be provided to the user through the at least one property advisor device. Further, the at least one property advisor device, in an instance, may be an electronic device operated by the property advisor. Further, the at least one property advisor device, in an instance, may be configured to communicate with the online platform 100 over a communication network such as, but not limited to, a cellular network, a satellite network, a personal area network, Bluetooth, Internet and so on. Further, the at least one property advisor device, in an instance, may include IoT based devices such as (but not limited to) smartphones, smartwatches, laptops, PCs, tablets, and so on.

Further, at 1204, the method 1200 may include a step of receiving, using the communication device, a license data associated with the property advisor from the at least one property advisor device based on the request. Accordingly, the license data associated with the property adviser, in an instance, may include information associated with one or more licenses belonging to the property advisor. For instance, the license data may include information such as a unique number assigned by Nationwide Mortgage Licensing System and Registry (NMLS) for the MLO license associated with the property advisor, a unique number of the real estate salesperson license associated with the property advisor, a validity (e.g. expiring date, if any) of the MLO license and/or the real estate salesperson license, and so on. Further, in some embodiments, the method may include receiving personal information associated with the property advisor, such as (but not limited to) name, age, gender, location, and so on.

Further, at 1206, the method 1200 may include a step of validating, using a processing device, the license data by using data retrieved from one or more databases. Accordingly, the online platform 100, in an instance, may be configured to verify the license data provided by the user by retrieving information from one or more databases. Further, the one or more databases may include at least one of government verified databases (such as, but not limited to, Nationwide Mortgage Licensing System, California Department of real estate, State of New Jersey Department of banking and insurance real estate commission), educational institution databases, and medical databases.

Further, at 1208, the method 1200 may include a step of storing, using a storage device, the license data in a database based on the validating. Accordingly, the database (such as database 108), in an instance, may be a storage device configured to store the license data associated with the property advisor in an organized formed that may be accessed electronically by the online platform 100.

Accordingly, in some embodiments, once the license data and the personal information associated with the property advisor may be verified, the online platform 100 may be configured to create a user profile associated with the property advisor.

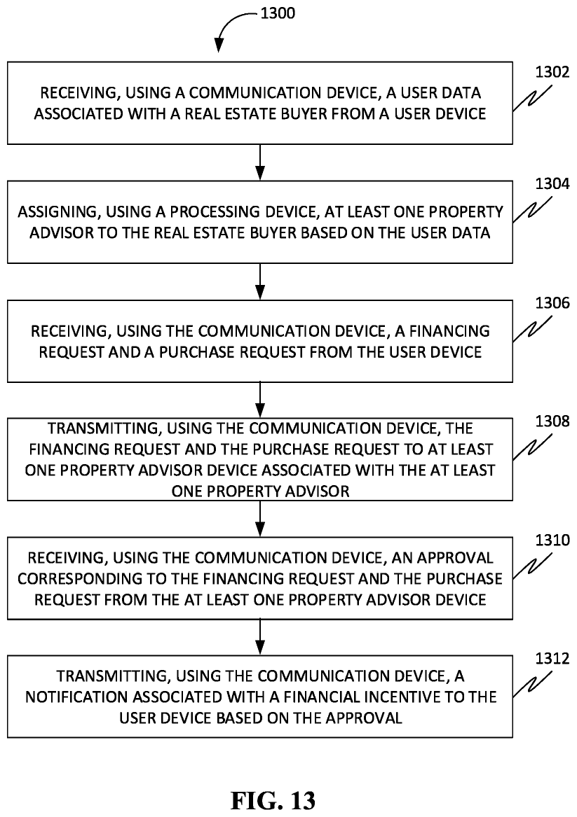

FIG. 13 is a flowchart of a method 1300 to facilitate combining mortgage business and brokerage business to provide financial incentives to real estate buyers, in accordance with some embodiments. Accordingly, at 1302, the method 1300 may include a step of receiving, using a communication device, a user data associated with a real estate buyer from a user device (such as the mobile device 104 and an electronic device in the electronic devices 106). Further, the real estate buyer, in an instance, may be a user that may wish to buy any real estate property through the online platform 100. Further, real estate buyer, in an instance, may be referred to as a homebuyer. Further, the user data, in an instance, may be any data that may reflect one or more characteristics of the real estate buyer. For instance, the user data may include information such as (but not limited to) personal details (e.g. name, age, gender, location of residence etc. associated with the real estate buyer), occupational details (e.g. type of profession, salary, professional position, location etc. associated with the real estate buyer), property requirement information (e.g. area associated with a house, number of rooms, number of bathrooms, location of the house etc. associated with the real estate buyer), and so on. Further, the real estate buyer, in an instance, may interact with the user device in order to provide the user data to the online platform 100. Further, the user device, in an instance, may be an electronic device operated by the real estate buyer. Further, the user device, in an instance, may be configured to communicate with the online platform 100 over a communication network such as, but not limited to, a cellular network, a satellite network, a personal area network, Bluetooth, Internet and so on. Further, the user device, in an instance, may include IoT based devices such as (but not limited to) smartphones, smartwatches, laptops, PCs, tablets, and so on.

Further, at 1304, the method 1300 may include a step of assigning, using a processing device, at least one property advisor to the real-estate buyer based on the user data. Accordingly, the online platform 100, in an instance, may be configured to assign the at least one property advisor (to the real estate buyer) that may be best suited for the real estate buyer based on the user data. Further, the at least one property advisor, in an instance, may be an individual (and/or a firm) that may be holding both real estate salesperson license and Mortgage Loan Originator (MLO) license in order to provide assistance to the real estate buyer. For instance, the at least one property advisor may be an authorized professional that may act as a real estate broker and a loan officer in a manner such that the real estate buyer may receive loan for the purchase of a real estate property along with some financial incentives (such as rebate of brokerage commission).

Further, at 1306, the method 1300 may include a step of receiving, using the communication device, the financing request and the purchase request from the user device. Accordingly, the financing request, in an instance, may be a request from the real estate buyer reflecting financial funding requirement for the purchase of a real estate property. For instance, the financing request may include an amount associated with a home loan that may be required for the purchase. Further, the purchase request, in an instance, may be a request from the real estate buyer reflecting requirement of communicating with another party (such as a seller of the real estate property) in order to facilitate the purchase.

Further, at 1308, the method 1300 may include a step of transmitting, using the communication device, the financing request and the purchase request to at least one property advisor device associated with the at least one property advisor. Accordingly, the at least one property advisor device, in an instance, may be an IoT based device operated by the at least one property advisor. Further, the at least one property advisor device, in an instance, may allow the at least one property advisor to communicate with the online platform 100. Further, the at least one property advisor device, in an instance, may include devices such as (but not limited to) smartphones, smartwatches, laptops, PCs, tablets, and so on. Further, the online platform 100, in an instance, may be configured to transmit the financing request and the purchase request to the at least one property advisor device through a wireless transmitter. The wireless transmitter, in an instance, may transmit the financing request and the purchase request over, but not limited to, a Wi-Fi, a Bluetooth, an electromagnetic waveform, ultra-sound, cellular (5G) and/or an Infra-red etc.

Further, at 1310, the method 1300 may include a step of receiving, using the communication device, an approval corresponding to the financing request and the purchase request from the at least one property advisor device. Accordingly, based on the approval of the financing request and the purchase request, all necessary transaction for the purchase of the real estate property may be carried out.

Further, at 1312, the method 1300 may include a step of transmitting, using the communication device, a notification associated with the financial incentive to the user device based on the approval. Accordingly, the financial incentives, in an instance, may be benefits that may be received by the real estate buyer with the purchase of the real estate property through the online platform 100. For instance, the financial incentives may include return of most of brokerage commission. For instance, the online platform 100 may be configured to return all of brokerage commission (to a bank account associated with the real estate buyer) that may be exceeding, e.g., 2% of a price at which the real estate property may be purchased by the real estate buyer.

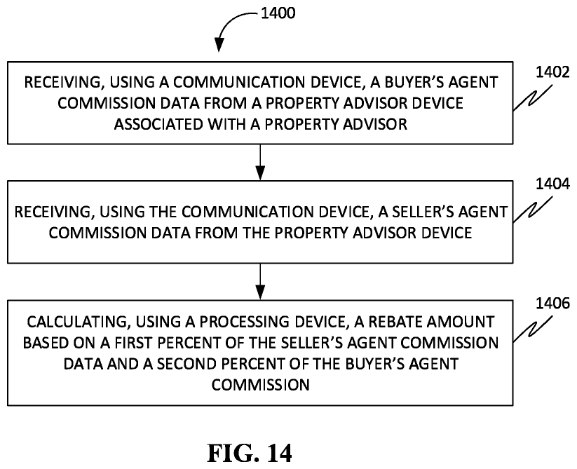

FIG. 14 is a flowchart of a method 1400 to facilitate determining a rebate amount for a purchase of a real estate property, in accordance with some embodiments. Accordingly, at 1402, the method 1400 may include a step of receiving, using a communication device, a buyer's agent commission data from a property advisor device associated with a property advisor. Further, the buyer's agent commission data, in an instance, may include an amount of commission that may be received by the buyer's agent. For instance, the amount of commission that may be received by the buyer's agent may be 1 percent of a purchase price. Further, the property advisor, in an instance, may be an individual (and/or a firm) that may be holding both real estate salesperson license and Mortgage Loan Originator (MLO) license in order to provide assistance to a real estate buyer. For instance, the property advisor may be an authorized professional that may act as a real estate broker and a loan officer in a manner such that the real estate buyer may receive loan for the purchase of a real estate property along with some financial incentives (such as rebate of brokerage commission). Further, the property advisor device, in an instance, may be an IoT based device operated by the property advisor. Further, the property advisor device, in an instance, may allow the property advisor to communicate with the online platform 100. Further, the property advisor device, in an instance, may include devices such as (but not limited to) smartphones, smartwatches, laptops, PCs, tablets, and so on.

Further, at 1404, the method 1400 may include the method may include a step of receiving, using the communication device, a seller's agent commission data from the property advisor device. Accordingly, the seller's agent commission data, in an instance, may include an amount of commission that may be received by a seller's agent. For instance, the amount of commission that may be received by the buyer's agent may be 1 percent of the purchase price.

Further, at 1406, the method 1400 may include a step of calculating, using a processing device, a rebate amount based on a first percent of the seller's agent commission data and a second percent of the buyer's agent commission. For instance, the rebate amount may be calculated based on (for e.g.) 3 percent of buyer's agent commission and 3 percent of seller's agent commission. Further, in some embodiments, the rebate amount may include all of brokerage commission that may be exceeding, e.g., 2% of the purchasing price. According to some embodiments, methods, systems, apparatuses and devices for facilitating combining of mortgage business and brokerage business to provide financial incentives to real estate buyers are disclosed.

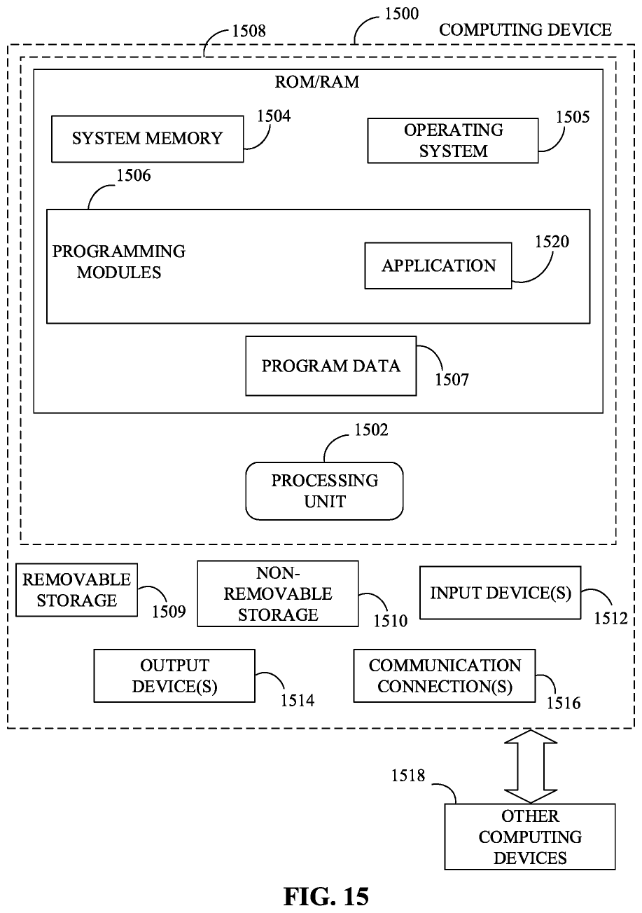

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include image-processing module, machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and non-volatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

We claim:

1. A method of facilitating an integrated provisioning of mortgage service and brokerage service to a buyer, the method comprising:
receiving, using a communication device, a mortgage request from a buyer device, wherein the mortgage request is associated with a real estate property;
generating, using a processing device, a mortgage transaction identifier based on the mortgage request;
receiving, using the communication device, a brokerage request from the buyer device, wherein the brokerage request is associated with the real estate property;
generating, using the processing device, a brokerage transaction identifier based on the brokerage request;
comparing, using the processing device, the mortgage transaction identifier and the brokerage transaction identifier;
generating, using the processing device, at least one monetary benefit based on the comparing, wherein the at least one monetary benefit is associated with at least one of a mortgage service fee and a brokerage service fee; and
transmitting, using the communication device, an indication of the at least one monetary benefit to the buyer device.

2. The method of claim 1, wherein the mortgage request comprises a request for financial funding for the purchase of the real estate property.

3. The method of claim 1, wherein the brokerage request comprises a request to communicate with a seller of the real estate property.

4. The method of claim 1 further comprising:
receiving, using the communication device, buyer agent commission data from a buyer agent device associated with a buyer agent, wherein the buyer agent facilitates the purchase of the real estate property;
receiving, using the communication device, seller agent commission data from a seller agent device associated with a seller agent, wherein the seller agent facilitates the selling of the real estate property; and
calculating, using the processing device, a rebate amount based on a first percent of the seller agent commission data and a second percent of the buyer agent commission data.

5. The method of claim 1, wherein the at least one monetary benefit comprises at least one of a mortgage fee discount and a brokerage fee discount associated with the at least one of the mortgage service fee and the brokerage service fee.

6. The method of claim 1 further comprising:
receiving, using the communication device, mortgage service provider data from a mortgage service provider device associated with a mortgage service provider; and
analyzing, using the processing device, the mortgage service provider data and the mortgage request to determine the mortgage service fee.

7. The method of claim 1 further comprising:
receiving, using the communication device, brokerage service provider data form a brokerage service provider device associated with a brokerage service provider; and
analyzing, using the processing device, the broker service provider data and the brokerage request to determine the brokerage service fee.

8. The method of claim 1 further comprising:
retrieving, using a storage device, financial data associated with a buyer, wherein the storage device is communicatively coupled with the processing device; and
analyzing, using the processing device, the financial data to determine the buyer eligibility for a mortgage.

9. A method of facilitating an integrated provisioning of mortgage service and brokerage service to a buyer, the method comprising:
receiving, using a communication device, a mortgage request from a buyer device, wherein the mortgage request is associated with a real estate property;
receiving, using the communication device, a brokerage request from the buyer device, wherein the brokerage request is associated with the real estate property;
identifying, using a processing device, a combined professional based on each of the mortgage request and the brokerage request, wherein the combined professional is qualified to deliver each of a mortgage service and a brokerage service;
transmitting, using the communication device, each of the mortgage request and the brokerage request to a combined professional device associated with the combined professional;
receiving, using the communication device, each of a mortgage service fee associated with the mortgage service and a brokerage service fee associated with the brokerage service from the combined professional device;
receiving, using the communication device, at least one of a mortgage fee discount and a brokerage fee discount from the combined professional device; and
transmitting, using the communication device, an indication of the at least one of the mortgage fee discount and the brokerage fee discount to the buyer device, wherein at least one of a mortgage fee payment associated with the mortgage service and a brokerage fee payment associated with the brokerage service is based on at least one of the mortgage fee discount and the brokerage fee discount.

10. The method of claim 9 further comprising:
retrieving, using a storage device, financial data associated with a buyer, wherein the storage device is communicatively coupled with the processing device; and
analyzing, using the processing device, the financial data to determine the buyer eligibility for a mortgage.

11. The method of claim 9 comprising:
receiving, using the communication device, a request to register as the combined professional from a combined professional device;
receiving, using the communication device, profile data associated with the combined professional from the combined professional device;
analyzing, using the processing device, the profile data to determine the eligibility of the combined professional; and
validating, using the processing device, the eligibility of the combined professional based on the analyzing.

12. The method of claim 11, wherein the eligibility of the combined professional is validated based on a third-party database, wherein the third party database is associated with a third party.

13. A system of facilitating an integrated provisioning of mortgage service and brokerage service to a buyer, the system comprising:
a communication device configured for:
receiving a mortgage request from a buyer device, wherein the mortgage request is associated with a real estate property;
receiving a brokerage request from the buyer device, wherein the brokerage request is associated with the real estate property; and
transmitting an indication of the at least one monetary benefit to the buyer device; and
a processing device configured for:
generating a mortgage transaction identifier based on the mortgage request;
generating a brokerage transaction identifier based on the brokerage request;
comparing the mortgage transaction identifier and the brokerage transaction identifier; and
generating at least one monetary benefit based on the comparing, wherein the at least one monetary benefit is associated with at least one of a mortgage service fee and a brokerage service fee.

14. The system of claim 13, wherein the mortgage request comprises a request for financial funding for the purchase of the real estate property.

15. The system of claim 13, wherein the brokerage request comprises a request to communicate with a seller of the real estate property.

16. The system of claim 13 further comprising the communication device configured for:
receiving buyer agent commission data from a buyer agent device associated with a buyer agent, wherein the buyer agent facilitates the purchase of the real estate property; and
receiving seller agent commission data from a seller agent device associated with a seller agent, wherein the seller agent facilitates the selling of the real estate property; and
the processing device configured for calculating a rebate amount based on a first percent of the seller agent commission data and a second percent of the buyer agent commission data.

17. The system of claim 13, wherein the at least one monetary benefit comprises at least one of a mortgage fee discount and a brokerage fee discount associated with the at least one of the mortgage service fee and the brokerage service fee.

18. The system of claim 13 further comprising the communication device configured for receiving mortgage service provider data from a mortgage service provider device associated with a mortgage service provider; and
the processing device configured for analyzing the mortgage service provider data and the mortgage request to determine the mortgage service fee.

19. The system of claim 13 further comprising the communication device configured for receiving brokerage service provider data form a brokerage service provider device associated with a brokerage service provider; and
the processing device configured for analyzing the broker service provider data and the brokerage request to determine the brokerage service fee.

20. The system of claim 13 further comprising a storage device communicatively coupled with the processing device, wherein the storage device configured for retrieving financial data associated with a buyer; and
the processing device configured for analyzing the financial data to determine the buyer eligibility for a mortgage.
